(19) United States
(12) Patent Application Publication
(10) Pub. No.: US 2021/0256713 A1
(43) Pub. Date: Aug. 19, 2021

(54) IMAGE PROCESSING APPARATUS AND IMAGE PROCESSING METHOD

(71) Applicant: CANON KABUSHIKI KAISHA, Tokyo (JP)

(72) Inventor: Hiroyasu Katagawa, Kanagawa (JP)

(21) Appl. No.: 17/174,178

(22) Filed: Feb. 11, 2021

(30) Foreign Application Priority Data
Feb. 13, 2020 (JP) 2020-022671

(51) Int. Cl. G06T 7/246; G06K 9/62; G06K 9/20

(52) U.S. Cl. CPC G06T 7/248; G06K 9/6215; G06K 2209/21; G06K 2009/6213; G06K 9/2081

(57) ABSTRACT

An image processing apparatus comprises a generating unit configured to generate a reference image for object tracking processing from an object included in the image, a matching unit configured to estimate a partial area having a degree of similarity higher than a predetermined value obtained by collating a partial area of a successively input image with the reference image, an updating unit configured to update the reference image based on the partial area estimated by the matching unit, and a determining unit configured to determine whether or not to update the reference image based on a comparison of the degree of similarity obtained by the matching unit with a threshold.

### BACKGROUND OF THE INVENTION

### Field of the Invention

The present invention relates to an image processing techniques for tracking an object included in an image.

### Description of the Related Art

Recently, techniques for extracting a specific object from an image and tracking the extracted object has been utilized, for example, for identifying a face area or a body area of a person in a moving image. Such techniques are utilized in, for example, communicating conferences, man-machine interfaces, security, monitoring systems for tracking arbitrary object, image compression, and/or the like.

Further, in an age capture apparatus such as a digital camera for capturing a moving image or a still image, by extracting and tracking arbitrary object included in the captured image, techniques for optimizing a focus state and an exposure state with respect to the object is known (Japanese Patent Laid-Open No. 2005-318554).

In addition, techniques for tracking a specific object using a method of template matching is known (Japanese Patent Laid-Open No. 2001-060269). The template matching is a method of registering a partial image obtained by cutting out an image area including a specific object to be tracked as a reference image (template image), estimating an area having the highest degree of similarity or the lowest degree of difference from the reference image, and tracking the specific object.

In addition, some digital cameras have an electronic viewfinder (EVF) function that displays an image (moving image) of an object on an LCD and/or the like before capturing a still image. A user checks a layout of the image before capturing by using the EVF function, etc., and when the shutter-release button is pressed, a still image whose focus position is adjusted by auto focus processing is captured.

When the auto focus processing is executed, it is necessary to determine the focus position at high speed in order to improve a responsiveness from a shooting instruction of the user to an execution of the image capturing operation, and therefore a higher frame rate such as 240 fps is desirable as the frame rate. Also, in order to determine the focus position at high speed, it is necessary to perform faster than the determination of the object to be focused, it is desirable to be performed at higher frame rate than object tracking processing.

However, when performing the template matching at high frame rate, since the reference image is frequently updated in a short time, when the reference image slightly deviates from the object area, it is assumed that the deviation is accumulated and deviated to an area other than the object. On the contrary, when performing the template matching at low frame rate, the frequency of updating the reference image is low, and therefore, a specific object can be kept tracked with little accumulated deviation. On the other hand, at low frame rate, a degree of similarity between an object with a lot of movement (tracking object) and a reference image becomes too low to track the object.

### SUMMARY OF THE INVENTION

The present invention has been made in consideration of the aforementioned problems, and realizes techniques capable of improving a tracking performance of an object by appropriately controlling updating of a reference image used for the template matching.

In order to solve the aforementioned problems, the present invention provides an image processing apparatus comprising: a memory and at least one processor and/or at least one circuit which function as: a generating unit configured to generate a reference image for object tracking processing from an object included in the image; a matching unit configured to estimate a partial area having a degree of similarity higher than a predetermined value obtained by collating a partial area of a successively input image with the reference image; an updating unit configured to update the reference image based on the partial area estimated by the matching unit; and a determining unit configured to determine whether or not to update the reference image based on a comparison of the degree of similarity obtained by the matching unit with a threshold.

In order to solve the aforementioned problems, the present invention provides an image processing method comprising: generating a reference image used for object tracking processing from the object included in the image; estimating a partial area having a degree of similarity higher than a predetermined value obtained by collating a partial area of a successively input image with the reference image; updating the reference image based on the partial area estimated to have a high degree of similarity; and determining whether to update the reference image based on a comparison of the degree of similarity with a threshold.

In order to solve the aforementioned problems, the present invention provides a non-transitory computer-readable storage medium storing a program that causes a computer to execute an image processing method comprising: generating a reference image used for object tracking processing from the object included in the image; estimating a partial area having a degree of similarity higher than a predetermined value obtained by collating a partial area of a successively input image with the reference image; updating the reference image based on the partial area estimated to have a high degree of similarity; and determining whether to update the reference image based on a comparison of the degree of similarity with a threshold.

According to the present invention, the updating of the reference images used for template matching can be appropriately controlled, and the tracking performance of the object can be improved,

Further features of the present invention will become apparent from the following description of exemplary embodiments (with reference to the attached drawings).

### BRIEF DESCRIPTION OF THE DRAWINGS

FIG. 1 is a block diagram illustrating an apparatus configuration according to a present embodiment.

FIG. 2 is a block diagram illustrating a configuration of an object tracking unit according to the present embodiment.

FIGS. 3A and 3B are diagrams illustrating a template matching according to the present embodiment.

FIG. 4 is a flowchart illustrating object tracking processing according to a first embodiment.

FIG. 5 is a diagram illustrating object tracking processing according to the first embodiment

FIG. 6 is a flowchart illustrating threshold calculation processing according to the first embodiment.

FIG. 7 illustrates a relationship between a degree of correlation (degree of similarity) and a threshold.

FIG. 8 is a flowchart illustrating threshold calculation processing according to a second embodiment.

FIG. 9 is a flowchart illustrating threshold calculation processing according to a third embodiment.

### DESCRIPTION OF THE EMBODIMENTS

Hereinafter, embodiments will be described in detail with reference to the accompanying drawings. The following embodiments do not limit the claimed invention. Although a plurality of features are described in the embodiments, not all of the plurality of features are essential to the present invention, and the plurality of features may be arbitrarily combined. Furthermore, in the accompanying drawings, the same reference numerals are assigned to the same or similar components, and a repetitive description thereof is omitted.

### First Embodiment

Hereinafter, an embodiment in which the image processing apparatus of the present invention is applied to a digital camera capable of capturing a still image or a moving image will be described in detail with reference to the accompanying drawings.

In the present embodiment, an example in which the present invention is applied to a digital camera as an image processing apparatus is described, but the present invention is not limited thereto. For example, the information processing apparatus may be an information processing apparatus such as a smart phone or a tablet device, which is a type of cellular phone,

### Apparatus Configuration

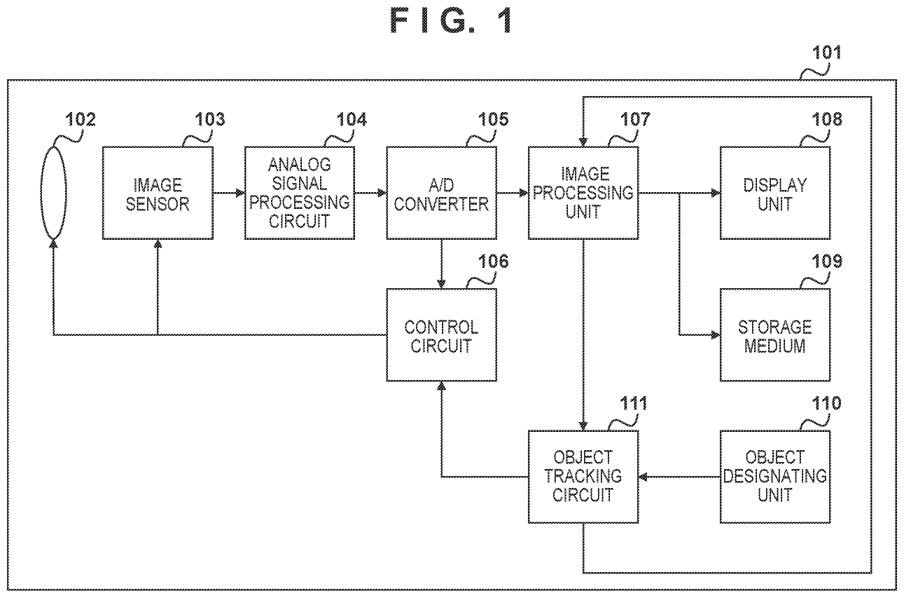

With reference to FIG. 1, the configuration and functions of the digital camera according to the present embodiment will be described.

The digital camera 101 of the present embodiment functions as an object tracking device for tracking an object included in an image sequentially input in time series.

The digital camera 101 includes an optical system 102, an image sensor 103, an analog signal processing circuit 104, an AID converter 105, a control circuit 106, an image processing circuit 107, a display unit 108, a storage medium 109, an object designating unit 110, and an object tracking unit 111.

The optical system 102 includes a lens, an aperture diaphragm, and/or the like that forms an object image and conducts the formed image to the image sensor 103. The image sensor 103 includes an imaging element such as a CCD a CMOS that photo-electrically converts an object image formed by the optical system 102 to generate analog image signal.

The A/D converter 105 includes circuitry for converting the analog image signal to digital signal.

The analog image signal output from the image sensor 103, analog signal processing such as correlated double sampling (CDS) is performed in the analog signal processing circuit 104. The image signal output from the analog. signal processing circuit 104 is converted into digital signal by the AID converter 105 is input to the control circuit 106 and the image processing circuit 107.

The control circuit 106 is, for example, a microcomputer and/or the like including a CPU, a ROM, and a RAM for controlling the entire operation of the digital camera 101. The control circuit 106 controls shooting conditions such as a focal state and an exposure state when performing image capture by the image sensor 103. For example, the control circuit 106, based on the video signal output from the A/D converter 105, controls a focus control mechanism and an exposure control mechanism of the optical system 102 (both not shown). The focus control mechanism is an actuator for driving the lens included in the optical system 102 in an optical axis direction, and/or the like. The exposure control mechanism is an actuator for driving the diaphragm aperture, the shutter, and/or the like. Further, the control circuit 106 performs reading control of the image sensor 103 such as timing and pixels for reading signal from the image sensor 103. The control circuit 106 expands the program codes stored in the ROM into the work area of the RAM and sequentially executes the program codes, thereby controlling each unit of the digital camera 101.

The image processing circuit 107, on the video signal output from the A/D converter 105, performs common image processing such as gamma correction processing and white balance processing. In addition to the common image processing, the image processing circuit 107 performs specific image processing using information regarding the object area in the image supplied from the object tracking circuit 111 that will be described later.

The video signal output from the image processing circuit 107 is output to a display unit 108. The display unit 108 is comprised of, for example, a liquid crystal or an organic EL, and displays the video signal. By sequentially displaying the image sequentially captured in time series by the image sensor 103 on the display unit 108, the display unit 108 functions as an electronic viewfinder (EVF). Further, the display unit 108 superimposes and displays the object area including the object tracked by the object tracking circuit 111 on the image by a rectangular frame and/or the like.

Further, the video signal output from the image processing circuit 107 is stored in the storage medium 109. The storage medium 109 is, for example, a detachable memory card. The recording destination of the video signal may be a built-in memory of the digital camera 101 or an external device (not shown) connected so as to be able to communicate with each other through a communication interface.

The object designating unit 110 is, for example, an input interface including a touch panel, a button, and/or the like. The user (photographer) can designate any object included in the image to be tracked through the object designating unit 110.

The object tracking circuit 111 tracks an image sequentially supplied from the image processing circuit 107 in time series, that is, an object that is captured by the image sensor 103 and is included in frames of which the read time is different. The object tracking circuit 111 estimates the object area from the images sequentially supplied by the object designating unit 110 based on the pixel pattern of the object. Further, the object tracking circuit 111 may include an object detecting circuit that detects a specific object such as face detection, and may track the detected object. Details of the object tracking circuit 111 will be described later.

The control circuit 106 may use the information of the object area supplied from the object tracking circuit 111 for controlling the focus control mechanism and the exposure control mechanism described above. Specifically, the focus control using the contrast value of the object area and the exposure control using the brightness value of the object area are performed. Thus, the digital camera 101, it is possible to perform the image capture processing in consideration of a specific object area in the captured image.

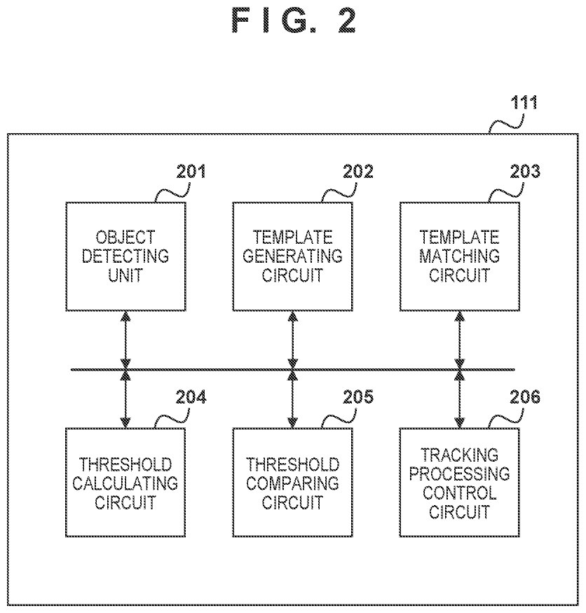

Here, details of the object tracking circuit 111 will be described. The object tracking circuit 111 performs matching processing (hereinafter referred to as template matching) for estimating an area having a degree of similarity higher than a predetermined value or a degree of difference lower than a predetermined value by collating a partial image indicating an object to be a tracking target as a template image with a partial area of a successively supplied image and changing the partial area to be compared. FIG. 2 is a block diagram illustrating a configuration of an object tracking circuit 111. The object tracking circuit 111 includes an object detecting circuit 201, a template generating circuit 202, a template matching circuit 203, a threshold calculating circuit 204, a threshold comparing circuit 205, and a tracking processing control circuit 206. Each block of the object detecting circuit 201 to the tracking processing control circuit 206 is connected by a bus and can exchange data.

The object detecting circuit 201 detects and identifies the object to be the tracking target from the images sequentially supplied from the image processing circuit 107. As the object to be the tracking target, for example, the face of a person is typical. In this case, the object detecting circuit 201 identifies the face area of the person as the object area and makes the face area of the person a tracking target. In the detection method of the object in the object detecting circuit 201, for example, when the detection target is a face of a person, a known face detection method may be used. As known techniques of the face detection, there are a method of utilizing knowledge about a face (skin color information, parts such as eyes, nose, and mouth) and a method of constructing a classifier for the face detection by a learning algorithm typified by a neural network. In the face detection, a face recognition is generally performed by combining the methods in order to improve the recognition accuracy. For example, there is a method of detecting a face by using a wavelet transform and an image feature quantity.

The template generating circuit 202 generates a partial image used for tracking the object from the object of the tracking target, and registers as a reference image (template image). In the template matching circuit 203, the template image registered by the template generating circuit 202 is collated with the partial area of the image sequentially supplied, and the partial area to be compared is changed to estimate an area in which the degree of similarity is higher than a predetermined value or the degree of difference is lower than a predetermined value.

The threshold calculating circuit 204 calculates a threshold for comparing the degree of similarity or the degree of difference obtained by the template matching circuit 203. Details of the threshold calculating circuit 204 will be described later.

The threshold comparing circuit 205 compares the degree of similarity or the degree of difference obtained by the template matching circuit 203 with the threshold obtained by the threshold calculating circuit 204, and outputs the comparison result.

The tracking processing control circuit 206 is configured by a CPU and/or the like, and controls object tracking processing. The object detecting circuit 201 to the threshold comparing circuit 205 perform processing through the tracking processing control circuit 206. In the tracking processing control circuit 206, the object area is determined from the evaluation value of the template matching circuit 203, Further, the tracking processing control circuit 206 controls whether to update the reference image in the template generating circuit 202 based on the comparison result of the threshold comparing circuit 205.

Further, the object area determined from the evaluation value of the template matching circuit 203 becomes the output information of the object tracking circuit 111.

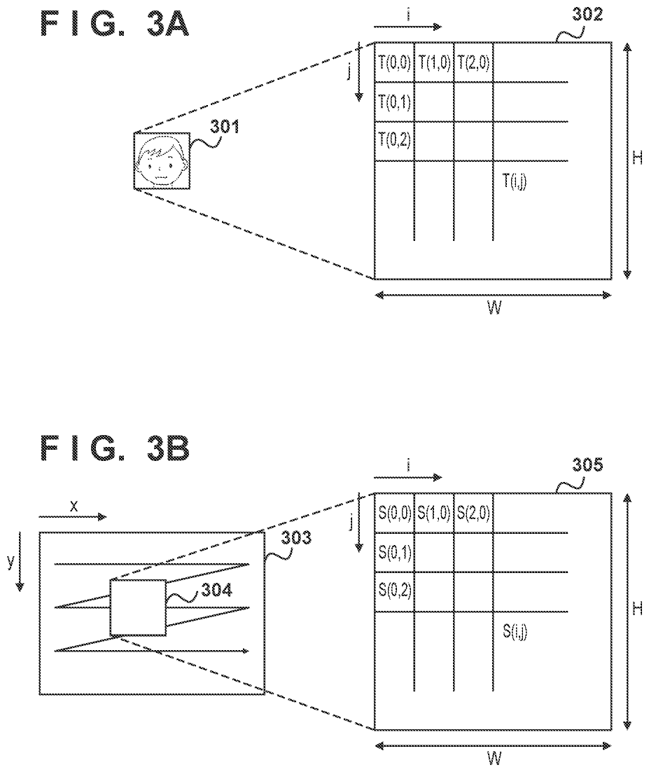

Next, with reference to FIGS. 3A and 3B, the template matching will be described.

FIG. 3A exemplifies reference images used for the template matching. The template image 301 is a partial image extracted from an object to be the tracking target, and a pixel pattern of the extracted partial image is used for template matching processing as a feature quantity. The feature quantity 302 represents feature quantities of each coordinate of the plurality of areas in the template image 301, and in the present embodiment, the luminance signal of the pixel data is used as the feature quantity. The feature quantity T (i, j) is expressed by Equation 1 when the coordinates in the template image area are (i, j), the number of horizontal pixels is W, and the number of vertical pixels is H.

T(i, j)={T(0, 0), T(1, 0), . . . , T(W−1, H−1)} (Equation 1)

FIG. 3B exemplifies information of images to be searched as the tracking target. The image 303 is an image in a range where the matching processing is performed. The coordinates in the search image are represented by (x, y). The partial area 304 is an area for obtaining an evaluation value of matching. The feature quantity 305 represents the feature quantity of the partial area 304, and the luminance signal of the image data is used as the feature quantity similar to the template image 301. The feature quantity S (i, j), the coordinates in the partial area (i, j), the number of horizontal pixels W, the number of vertical pixels and H, is represented by Equation 2.

S(i, j)={S(0, 0), S(1, 0), . . . , S(W−1, H−1) } (Equation 2)

In the present embodiment, a sum of absolute differences, so-called SAD (Sum of Absolute Difference) value, is used as a calculation method for evaluating the similarity between the template image 301 and the partial area 304. The SAD value is calculated by Equation 3.

V(x, y)=Σ_{y=0}^{H-1}Σₓ₌₀^{W-1}|T(i, j)−S(i,j) (Equation 3)

While shifting the partial area 304 by one pixel in order from the upper left of the image 303 of the search range, calculates the SAD value V (x, y). The coordinates (x, y) at which the calculated V(x, y) indicates the minimum value indicate the position most similar to the template image 301. In other words, the position indicating the minimum value is a position where there is a high possibility that the tracking target to be subjected in the searched image exists.

In the present embodiment, the one-dimensional information of the luminance signal is used as the feature quantity, but the three-dimensional information such as signals of brightness, hue, and/or color saturation may be treated as the feature quantity. In addition, although the SAD value has been described as a calculation method of the evaluation value of the matching, another calculation method such as normal cross-correlation, so-called NCC (Normalized Correlation Coefficient) and/or the like may be used.

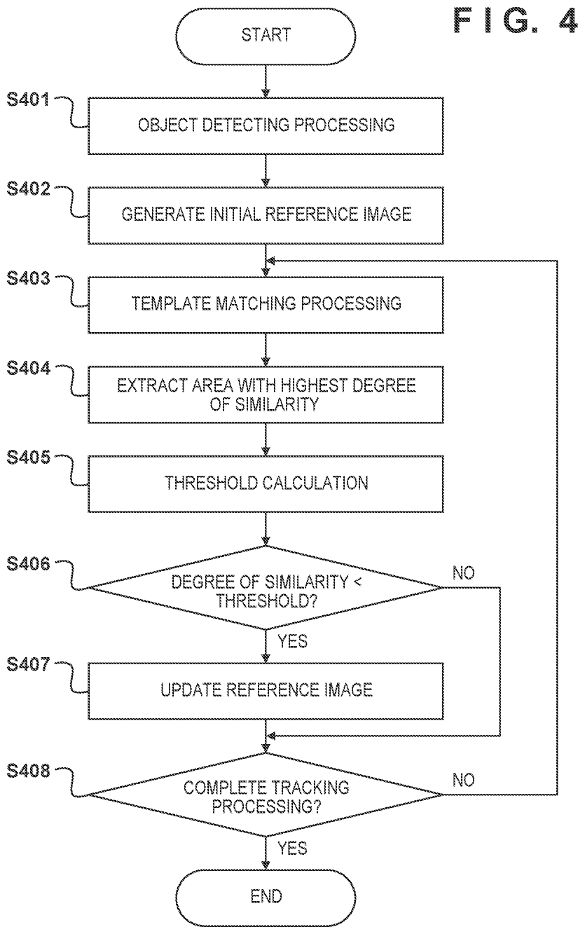

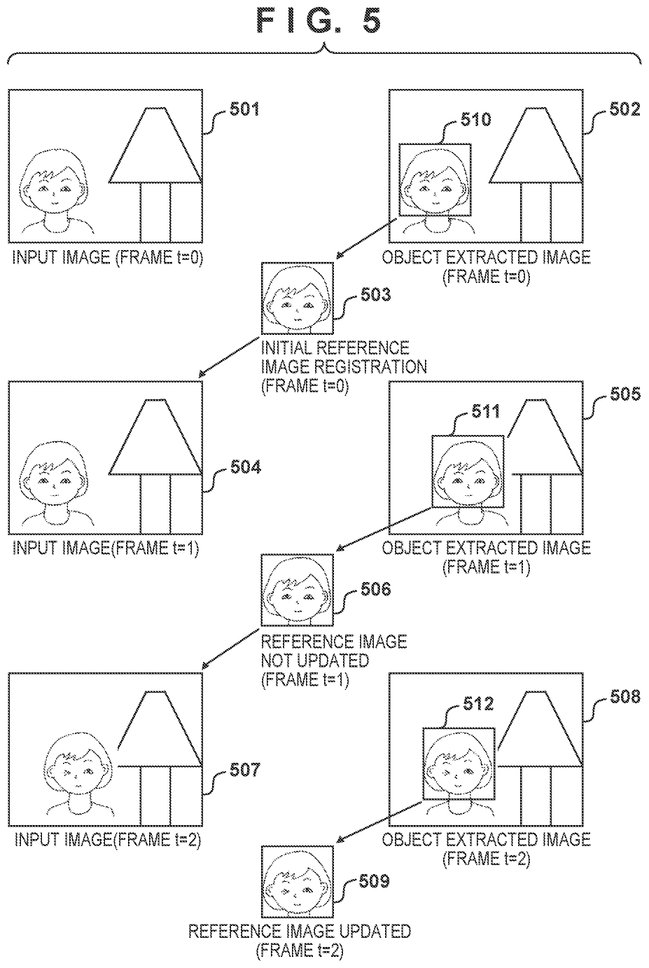

FIG. 4 is a flowchart illustrating object tracking processing according to the first embodiment. FIG. 5 is a diagram illustrating object tracking processing using the template matching.

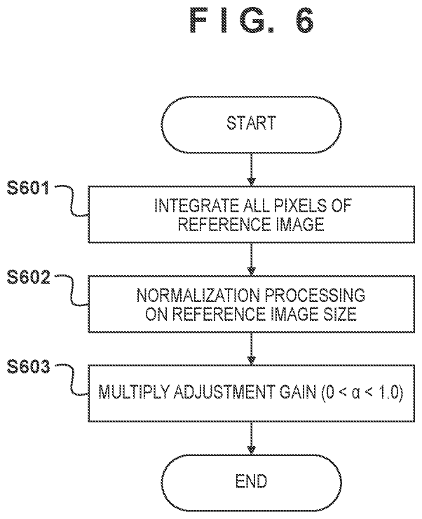

The processing of FIG. 4 is realized by the CPU of the control circuit 106 expanding a program stored in the ROM into the RAM and executing the program to control the object tracking circuit 111. The same applies to FIGS. 6, 8 and 9, which will be described later. The processing of FIG. 4 is started when the power of the digital camera 101 is turned on and the shooting mode is set.

In step S401, the object detecting circuit 201 of the object tracking circuit 111 reads the input image 501 at the frame performs the object detection processing such as the face detection processing, extracts the object area, and obtains the object detection result as indicated by the frame 510 in the image 502.

In step S402, the template generating circuit 202 of the object tracking circuit 111 generates and registers an initial reference image 503 from the object detection result in step S401.

In step S403, the template matching circuit 203 of the object tracking circuit 111 reads the input image 504 in the subsequent frame t=1, and performs the template matching processing on a partial area of the input image and a reference image registered in the input image in the frame t=0. When the entire area of the input image is compared with the reference image, the processing proceeds to step S404.

In step S404, the template matching circuit 203 of the object tracking circuit 111 estimates the area with the highest degree of correlation to be the object area at frame t=1, and obtains a matching result as indicated by a frame 511 in the image 505.

In step S405, the threshold calculating circuit 204 of the object tracking circuit 111 calculates a threshold for comparing with the degree of correlation (degree of similarity) calculated in step S404.

In step S406, the threshold comparing circuit 205 of the object tracking circuit 111 compares the degree of correlation (degree of similarity) calculated in step S405 with the threshold. Then, the tracking processing control circuit 206 of the object tracking circuit 111 determines whether or not the degree of correlation (degree of similarity) is smaller than the threshold based on the result of the comparison by the threshold comparing circuit 205, if the degree of correlation (degree of similarity) is smaller than the threshold, the processing proceeds to step S407, if the degree of correlation (degree of similarity) is equal to or higher than the threshold, the processing proceeds to step S408 without updating the reference image.

In step S407, the tracking processing control circuit 206 of the object tracking circuit III updates the reference image 503 obtained in the previous frame t=0 and registers the new reference image 506.

Further, in step S406, since the degree of correlation (degree of similarity) is equal to or greater than the threshold in the frame t=1, the reference image 506 is not updated and the reference image 503 at the time of the frame t=0 is held.

Then, the end determination of the tracking processing is performed in step S408, and when the tracking processing is not completed, the processing returns to step S403, the input image 507 in the next frame t=2 is read, and the matching processing between the partial area of the input image 507 and the reference image 506 at the frame t=1 is performed. When the matching processing is completed, it is estimated that the area having the highest degree of correlation is the object area in the frame t=2, and the matching result as indicated by the frame 512 is obtained in the image 508 in step S404. Then, a threshold is calculated (step S405), and the obtained degree of correlation (degree of similarity) is compared with the threshold (step S406).

Since the degree of correlation (degree of similarity) is smaller than the threshold in the frame t=2, a new reference image 509 is obtained in step S407,

As described above, the object of the tracking target is tracked by controlling whether or not to update the reference image on the basis of the degree of correlation (degree of similarity) between the image continuously input and the reference image obtained by the matching result in the previous frame.

Next, a processing flow of the threshold calculating circuit 204 of the object tracking circuit 111 according to the first embodiment will be described with reference to FIG. 6.

In the first embodiment, the threshold is calculated using the reference image in the initial frame (frame t=0).

In step S601, the threshold calculating circuit 204 of the object tracking circuit 111 adds all pixels of the reference image in the initial frame (frame t=0).

In step S602, the threshold calculating circuit 204 of the object tracking circuit 111 performs normalization processing on the value integrated by the size of the template image.

In step S603, the threshold calculating circuit 204 of the object tracking circuit 111 multiplies an adjustment gain a for comparing with the degree of correlation (degree of similarity).

Here, the threshold Th is calculated by Equation 4.

Th=((Σ_{y=0}^{H-1}Σₓ₌₀^{W-1}|T(i, j)−S(i, j)|)×α)/(H×W) (Equation 4)

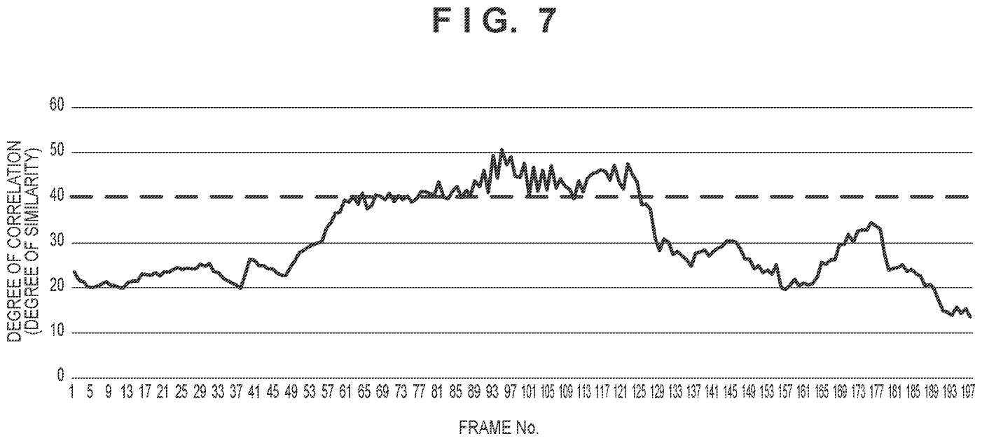

FIG. 7 exemplifies a relationship between threshold Th and a degree of correlation (degree of similarity). The horizontal axis indicates the frame No. and the vertical axis indicates the degree of correlation (degree of similarity), The threshold obtained by Equation 4 is assumed to be 40 here.

Then, in step S406 of FIG. 4, control is performed so that the reference image is updated when the degree of correlation (degree of similarity) is smaller than the threshold, and the reference image is not updated when the degree of correlation (degree of similarity) is equal to or greater than the threshold. In the example of FIG. 7, the reference image is not updated much around frames No. 60 to No. 120, and the reference image is updated frequently in other frames.

In the flow of FIG. 6, although the threshold is calculated using the reference image in the initial frame (frame t=0) and applied to the image after frame t=1, the threshold may be calculated for each frame (frame t=n−1) and applied to the next frame (frame t=n).

In the calculation of the threshold, the image used for integration of all the pixels may be luminance signal or signals of brightness, hue, and/or color saturation. Furthermore, configuration may be such that a part of the brightness, hue and color saturation signals are used, or the respective ratios are changed and integrated.

Although the threshold is calculated using the reference image in the flow of FIG. 6, the threshold may be calculated using not only the reference image but also the partial area to be compared, or the threshold may be calculated using both the reference image and the partial area to be compared.

Further, in FIG. 6, although the threshold was calculated using the normalized value of the result of integrating the pixel, i.e. the average value of the pixel, the threshold may be calculated using the integral value itself.

As described above, according to the present embodiment, since the reference image is not updated too much when the degree of correlation (degree of similarity) is high, for example, it is possible to prevent tracking processing in which the tracking target gradually moves to the background.

In addition, when the object undergoes a lot of movement, since the degree of correlation (degree of similarity) becomes a small value, the reference image is updated frequently, and as a result, even an object with a lot of movement can be tracked.

### Second Embodiment

Next, the second embodiment will be described.

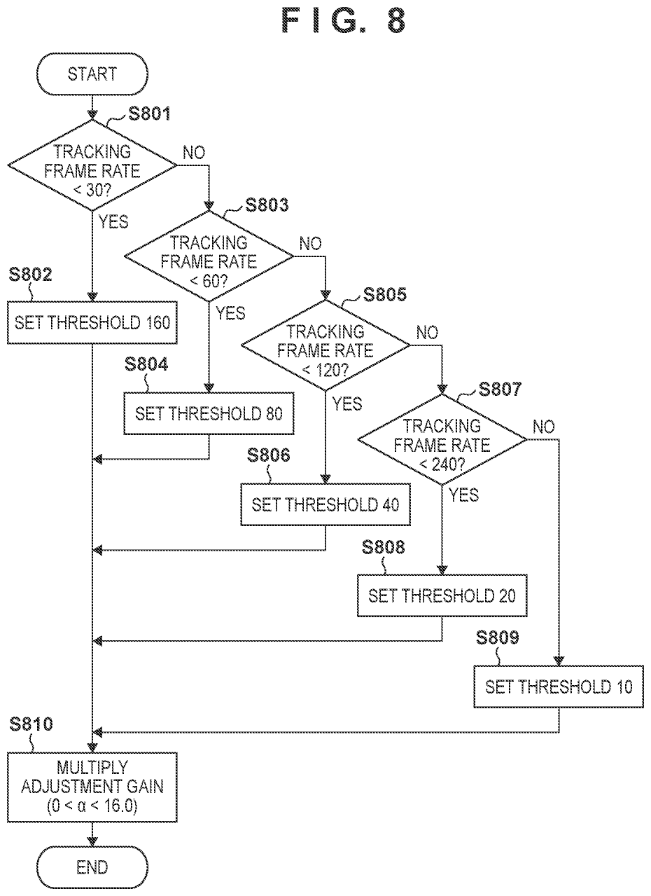

In the second embodiment, the difference from the first embodiment will be mainly described with reference to a flowchart showing the threshold calculation processing of FIG. 8.

The configuration of the digital camera 101 of FIG. 1, the object tracking circuit 111 of FIG. 2, and the object tracking processing of FIG. 4 are the same as those of the first embodiment.

In the second embodiment, the threshold is calculated in accordance with the frame rate at which the object is tracked.

In step S801, the threshold calculating circuit 204 of the object tracking circuit 111 determines whether the tracking frame rate is less than 30 fps. If the tracking frame rate is less than 30 fps, the processing proceeds to step S802, and the threshold 160 is set. When the tracking frame rate is 30 fps or more, the processing proceeds to step S803.

In step S803, the threshold calculating circuit 204 of the object tracking circuit 111 determines whether the tracking frame rate is less than 60 fps. If the tracking frame rate is less than 60 frames per second, the processing proceeds to step S804, and the threshold 80 is set. If the tracking frame rate is 60 fps or more, the processing proceeds to step S805.

In step S805, the threshold calculating circuit 204 of the object tracking circuit 111 determines whether the tracking frame rate is less than 120 fps. If the tracking frame rate is less than 120 fps, the processing proceeds to step S806, and the threshold 40 is set. If the tracking frame rate is 120 fps or more, the processing proceeds to step S807.

In step S807, the threshold calculating circuit 204 of the object tracking circuit 111 determines whether the tracking frame rate is less than 240 fps. If the tracking frame rate is less than 240 fps, the processing proceeds to step S808, and the threshold 20 is set. When the tracking frame rate is 240 fps or more, the processing proceeds to step S809, and the threshold 10 is set.

In the above-described processing, the higher the frame rate to be tracked, the smaller the value of the threshold to be set, and the control is performed so as to reduce the update frequency of the reference image at the high frame rate.

Threshold calculating circuit 204 outputs the final threshold by multiplying the adjustment gain α (0<α<16.0) with respect to the set threshold.

It is conceivable that the adjustment gain may be changed by sets such as exposure control of a digital camera.

This is because the degree of correlation (degree of similarity) of the template matching to be compared depends on the exposure, and for example, when EV−1 is set, a relatively large value is output, and when EV+1 is set, a relatively small value is output.

As described above, according to the present embodiment, since the reference image is updated frequently when the frame rate to be tracked is low, and the reference image is controlled not to be updated too much when the frame rate is high, for example, it is possible to prevent tracking processing in which the tracking target gradually transfers to the background.

In addition, when the object undergoes a lot of movement, since the degree of correlation (degree of similarity) becomes a small value even when the frame rate is high, the reference image is updated frequently, and as a result, even an object with a lot of movement can be tracked.

The threshold set in the present embodiment is an example, and any value may be set.

### Third Embodiment

Next, the third embodiment will be described.

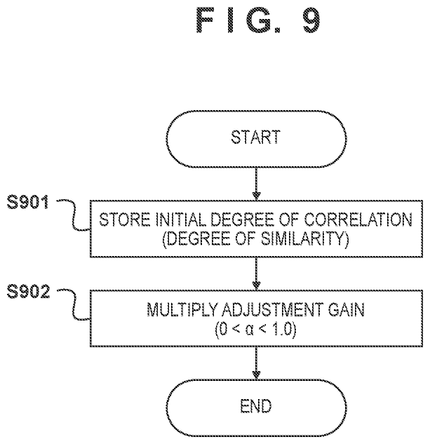

In the third embodiment, the difference from the first embodiment will be mainly described with reference to a flowchart showing the threshold calculation processing of FIG. 9.

The configuration of the digital camera 101 of FIG. 1, the object tracking circuit 111 of FIG. 2, and the object tracking processing of FIG. 4 are the same as those of the first embodiment.

In the third embodiment, the threshold is calculated from the initial degree of correlation (degree of similarity). The initial degree of correlation indicates the highest correlation value in the template matching processing between the initial reference image 503 and the input image 504.

The initial reference image 503 is calculated at frame t=0, and the initial degree of correlation (degree of similarity) is calculated at frame t=1. Since the threshold is calculated using this initial degree of correlation (degree of similarity), the applied frame becomes frame t=2 or later.

In the present embodiment, the object area obtained in the frame t=1 is updated as a reference image to be used in the next frame t=2.

In step S901, the threshold calculating circuit 204 of the object tracking circuit 111 stores the initial degree of correlation (degree of similarity) in a nonvolatile memory such as a ROM (not shown).

In step S902, the threshold calculating circuit 204 of the object tracking circuit 111 multiplies the adjustment gain α (0<α<1.0) with respect to the initial degree of correlation (degree of similarity) stored in step S901 to output a final threshold.

The adjustment gain may be frequently updated when the initial degree of correlation (degree of similarity) is high if the initial value of the degree of correlation (degree of similarity) is used as it is, and may be calculated by setting α=0.5, for example.

In the present embodiment, although the threshold is calculated using the initial degree of correlation (degree of similarity), the threshold may be calculated for each frame (frame t=n−1) and applied to the next frame (frame t=n).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and/or the like.

While the present invention has been described with reference to exemplary embodiments, it is to be understood that the invention is not limited to the disclosed exemplary embodiments. The scope of the following claims is to he accorded the broadest interpretation so as to encompass all such modifications and equivalent structures and functions.

This application claims the benefit of Japanese Patent Application No. 2020-022671, filed Feb. 13, 2020 which is hereby incorporated by reference herein in its entirety.

What is claimed is:

1. An image processing apparatus comprising:
a memory and at least one processor and/or at least one circuit which function as:
a generating unit configured to generate a reference image for object tracking processing from an object included in the image;
a matching unit configured to estimate a partial area having a degree of similarity higher than a predetermined value obtained by collating a partial area of a successively input image with the reference image;
an updating unit configured to update the reference image based on the partial area estimated by the matching unit; and
a determining unit configured to determine whether or not to update the reference image based on a comparison of the degree of similarity obtained by the matching unit with a threshold.

2. The apparatus according to claim 1, further comprising a control unit configured to perform control so as to update the reference image when the degree of similarity is lower than the threshold, and not to update the reference image when the degree of similarity is equal to or greater than the threshold.

3. The apparatus according to claim 1, wherein the degree of similarity is normalized by a size of the partial area.

4. The apparatus according to claim 1, wherein the threshold is determined based on an integral value of the pixels of the reference image or the estimated partial area.

5. The apparatus according to claim 1, wherein the threshold is determined based on an average value of pixels of the reference image or the estimated partial area.

6. The apparatus according to claim 1, wherein the threshold is determined based on a frame rate at which the matching unit performs the collation.

7. The apparatus according to claim 1, wherein the threshold is calculated from the degree of similarity of the previous frame.

8. The apparatus according to claim 1, further comprising an object detecting unit configured to detect a specific object from the input image, wherein of the reference images is generated using a result of detecting the particular object.

9. The apparatus according to claim 1, wherein the reference image is generated from a partial area of an object designated by a user.

10. An image processing method comprising:
generating a reference image used for object tracking processing from the object included in the image;
estimating a partial area having a. degree of similarity higher than a predetermined value obtained by collating a partial area of a successively input image with the reference image;
updating the reference image based on the partial area estimated to have a high degree of similarity; and
determining whether to update the reference image based on a comparison of the degree of similarity with a threshold.

11. A non-transitory computer-readable storage medium storing a program that causes a computer to execute an image processing method comprising:
generating a reference image used for object tracking processing from the object included in the image;
estimating a partial area having a degree of similarity higher than a predetermined value obtained by collating a partial area of a successively input image with the reference image;
updating the reference image based on the partial area estimated to have a high degree of similarity; and
determining whether to update the reference image based on a comparison of the degree of similarity with a threshold.
